(19) United States
(12) Patent Application Publication
(10) Pub. No.: US 2024/0359904 A1
(43) Pub. Date: Oct. 31, 2024

(54) HYDROGEN TEMPERATURE CONTROLLING SYSTEM, REFRIGERATED CONTAINING DEVICE, AND DIVISIONAL TEMPERATURE CONTROLLING METHOD FOR THE REFRIGERATED CONTAINING DEVICE

(71) Applicant: AUTOMOTIVE RESEARCH & TESTING CENTER, Changhua Hsien (TW)

(72) Inventor: Po-Hsu Lin, Changhua Hsien (TW)

(21) Appl. No.: 18/139,505

(22) Filed: Apr. 26, 2023

(51) Int. Cl. B65D 88/74; F25B 27/00; F25B 41/20; F25B 49/00; H01M 8/04007; H01M 8/04701

(52) U.S. Cl. CPC B65D 88/74; F25B 27/00; F25B 41/20; F25B 49/00; H01M 8/04067; H01M 8/04708; F25B 2600/2515; F25B 2700/2103; H01M 2250/30

(57) ABSTRACT

A refrigerated containing device has a hydrogen temperature controlling system having an expansion valve, multiple temperature controlling modules, and a control unit. Each temperature controlling module has a control valve, a heat exchanger, and a thermal sensor; the control unit is electrically connected to the control valve and the thermal sensor. A divisional temperature controlling method is applied for the refrigerated containing device; first, measure a temperature of a containing space in a container of the refrigerated containing device, and determine whether a difference between temperature of the containing space and a target temperature is within a range so as to decide whether the hydrogen gas with capabilities of heat absorption after flowing through the expansion valve flows through the control valve to the heat exchanger. Thereby, temperature of the containing space can be controlled accurately, and the cost-effectiveness of fuel cell system applied to refrigerated container is improved.

### BACKGROUND OF THE INVENTION

### 1. Field of the Invention

The present invention relates to a refrigeration system, and particularly to a hydrogen temperature controlling system, a refrigerated containing device, and a divisional temperature controlling method for the refrigerated containing device.

### 2. Description of Related Art

Refrigerated transport has been a fast-developing industry since the past few years. By disposing a refrigerated container on the truck, all kinds of commodities needing to be kept cold and fresh can be stored inside the container, which allows downstream suppliers or consumers to receive commodities with better quality.

In a primitive refrigerated truck, a compressor of a refrigeration system is connected to an engine of the truck via a connector such as a belt. The compressor is driven by the engine to compress refrigerant, and then the refrigerant is led to a refrigerating module of the refrigeration system. The refrigeration system thus runs a refrigeration cycle to lower the temperature inside the container and provide an effect of refrigeration. However, since the compressor is driven by the engine, the refrigeration system stops working when the truck stops for traffic signals or during discharge of the commodities. Moreover, the efficiency of the refrigeration system continually changes as the operating situation of the engine, i.e. the driving circumstances of the truck. Thereby, the commodities may not be stably kept in refrigeration.

In light of the above-mentioned problems of the original refrigerated truck, researchers in the industry developed the way of the compressor being driven by an external electricity module instead of the engine. Specifically, the external electricity module supplies electricity for driving the compressor via a motor, which helps the refrigeration system to run the refrigeration cycle. Thereby, when the truck stops, the refrigeration system may still operate. Otherwise, the commodities in the container can be stably kept in refrigeration without being influenced by the driving circumstances of the truck since the compressor is driven by the electric motor. However, capacity and weight of the external electricity module all need to be considered thoroughly, and the capacity of the external electricity module is limited and cannot allow the truck to transport for a long distance. Furthermore, the external electricity module needs a period of time to be recharged after running out of electricity, which interferes with trucks' schedule of the refrigerated transport.

With the trend of the hydrogen energy in recent years, many technics of fuel cell electric vehicles are gradually developed. Also, many researchers in this industry try to replace the external electricity module with the fuel cell system for supplying the motor with electricity, and the refrigeration system can run the refrigeration cycle to cool the interior of the container. However, according to the current cost of purchasing fuel cell electric vehicles and latter refueling of the hydrogen gas, the cost-effectiveness of applying the fuel cell system for running the refrigeration cycle to cool the interior of the container is at a low level. As a result, the applicant develops the present invention to mitigate or obviate the aforementioned problems.

### SUMMARY OF THE INVENTION

The main objective of the present invention is to provide a hydrogen temperature controlling system, a refrigerated containing device, and a divisional temperature controlling method for the refrigerated containing device that May control temperature divisionally by heat absorption capacity of decompressed gas, increase application of the fuel cell system, and improve the cost-effectiveness of the fuel cell system.

The hydrogen temperature controlling system is applied for supplying hydrogen gas and simultaneously controlling temperature of multiple containing spaces via the hydrogen gas. The hydrogen temperature controlling system has an expansion valve, multiple temperature controlling modules, and a control unit. The expansion valve is configured to allow the hydrogen gas to flow through to lower pressure and temperature of the hydrogen gas. Each one of the multiple temperature controlling modules has a control valve, a heat exchanger, and a thermal sensor. The control valve is configured to allow the hydrogen gas from the expansion valve to flow through. The heat exchanger is connected to the control valve and is configured to be disposed to a respective one of the multiple containing spaces. The thermal sensor is configured to be disposed to a respective one of the multiple containing spaces and measure temperature of the corresponding containing space. The control unit is electrically connected to the control valve and the thermal sensor of each one of the multiple temperature controlling modules. The hydrogen temperature controlling system is configured for the hydrogen gas to flow through the expansion valve and said temperature controlling module to an outlet pipeline, and the control unit is configured to operate the control valve of each one of the multiple temperature controlling modules according to temperature of the corresponding containing space so as to allow the hydrogen gas to flow to the corresponding heat exchanger, so the heat exchanger exchanges heat with the corresponding containing space.

The refrigerated containing device has the hydrogen temperature controlling system described above, a container, a storage tank, a fuel cell, an actuator, and a refrigeration system. The container has the multiple containing space disposed therein. The storage tank is configured to store the hydrogen gas and supply the hydrogen gas to the expansion valve of the hydrogen temperature controlling system. The fuel cell is configured to receive the hydrogen gas from the outlet pipeline of the hydrogen temperature controlling system and generate electricity. The actuator is configured to operate with the electricity generated by the fuel cell, and the refrigeration system is drivable by the actuator to cool an interior of the container.

The divisional temperature controlling method for a refrigerated containing device has the following steps. Allow hydrogen gas to flow through an expansion valve to lower pressure and temperature of the hydrogen gas; measure temperature of a first containing space inside a container, and determine whether a difference between the temperature of the first containing space and a first target temperature is within a range. When the difference between the temperature of the first containing space and the first target temperature is within the range, actuate a first control valve to allow the hydrogen gas to flow through a first heat exchanger so as to exchange heat with the first containing space via the first heat exchanger. Measure temperature of a second containing space inside the container, and determine whether a difference between the temperature of the second containing space and a second target temperature is within the range. When the difference between the temperature of the second containing space and the second target temperature is within the range, actuate a second control valve to allow the hydrogen gas to flow through a second heat exchanger so as to exchange heat with the second containing space via the second heat exchanger.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of pipeline arrangement of a refrigerated containing device applying a hydrogen temperature controlling system of a first preferred embodiment in accordance with the present invention;

FIG. 2 is a system block diagram of the refrigerated containing device in FIG. 1;

FIG. 3 is a perspective view of the refrigerated containing device in FIG. 1;

FIG. 4 is a perspective view of a heat exchanger and a frame of the hydrogen temperature controlling system in FIG. 1;

FIG. 5 is a sectional top side view of the frame in FIG. 4;

FIGS. 6A and 6B are process diagrams of a divisional temperature controlling method for the refrigerated containing device in FIG. 1;

FIGS. 7 to 9 are operational views of the hydrogen temperature controlling system in FIG. 1;

FIG. 10 is a perspective view of a truck applying the refrigerated containing device in FIG. 1;

FIG. 11 is a perspective view of a refrigerated containing device of a second preferred embodiment in accordance with the present invention; and

FIG. 12 is an enlarged sectional side view of the refrigerated containing device in FIG. 11.

### DETAILED DESCRIPTION OF THE PREFERRED EMBODIMENT

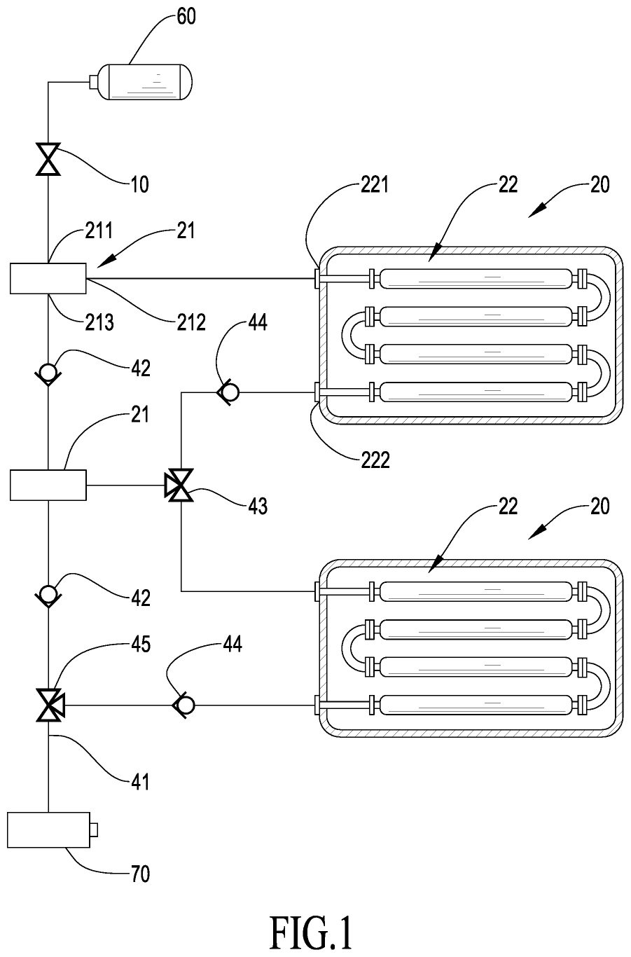

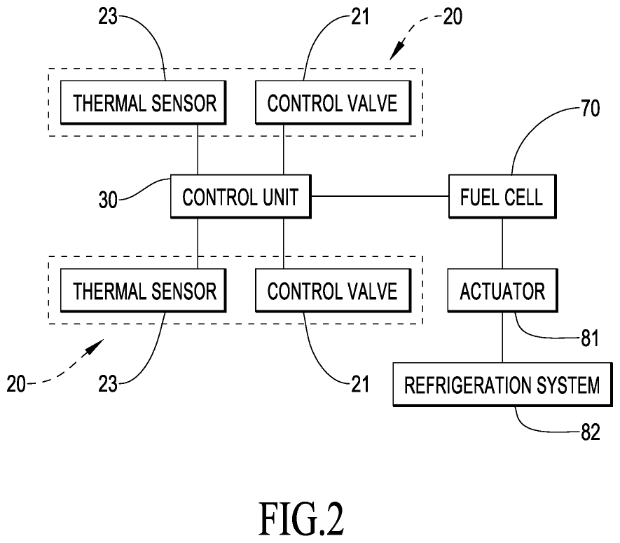

A hydrogen temperature controlling system of a first preferred embodiment in accordance with the present invention is applied for supplying hydrogen gas and simultaneously controlling temperature of multiple containing spaces via the hydrogen gas. With reference to FIGS. 1 and 2, the hydrogen temperature controlling system has an expansion valve 10, multiple temperature controlling modules 20, and a control unit 30.

The expansion valve 10 is configured to allow the hydrogen gas to flow through to lower pressure and temperature of the hydrogen gas. Specifically, the hydrogen gas is throttled by the expansion valve 10, which lowers pressure and temperature of the hydrogen gas and makes the hydrogen gas have the capability of heat absorption to exchange heat with a space having a higher temperature.

With reference to FIGS. 1 and 2, each one of the multiple temperature controlling modules 20 has a control valve 21, a heat exchanger 22, and a thermal sensor 23. The control valve 21 allows the hydrogen gas from the expansion valve 10 to flow through. The heat exchanger 22 is connected to the control valve 21 and is configured to be disposed to a respective one of the multiple containing spaces. With reference to FIG. 1, in the first preferred embodiment, the hydrogen temperature controlling system has two temperature controlling modules 20, and said heat exchangers 22 of the two temperature controlling modules 20 respectively correspond to two said containing spaces.

The thermal sensor 23 of each one of the two temperature controlling modules 20 is configured to be disposed in anywhere of a respective one of the two containing spaces. With reference to FIG. 2, the control unit 30 is electrically connected to the control valve 21 and the thermal sensor 23 of each one of the multiple temperature controlling modules 20. The control unit 30 is configured to receive a temperature information of each one of the multiple containing spaces from the corresponding thermal sensor 23 and operate the corresponding control valve 21 according to the temperature information. Specifically, the control valve 21 is a solenoid valve, and the control unit 30 is able to send an electrical signal to the control valve 21 and actuate the control valve 21.

With reference to FIG. 1, the hydrogen temperature controlling system is configured for the hydrogen gas to flow through the expansion valve 10 and said temperature controlling module 20 to an outlet pipeline 41. The control unit 30 operates the control valve 21 of each one of the multiple temperature controlling modules according to the temperature information received from the corresponding thermal sensor 23 so as to allow the hydrogen gas to flow to the corresponding heat exchanger 22, so the heat exchanger 22 exchanges heat with air in the corresponding containing space. Concerning the application of the hydrogen temperature controlling system, details are described below with a refrigerated containing device applying the hydrogen temperature controlling system.

With reference to FIGS. 1 to 3, the refrigerated containing device applying the hydrogen temperature controlling system of the first preferred embodiment further has a container 50, a storage tank 60, a fuel cell 70, an actuator 81, and a refrigeration system 82. The container 50 has the two containing spaces disposed therein. The storage tank 60 is configured to store the hydrogen gas and supply the hydrogen gas to the expansion valve 10. The fuel cell 70 is connected to the outlet pipeline 41 of the hydrogen temperature controlling system and is configured to receive the hydrogen gas from the outlet pipeline 41 and generate electricity. The actuator 81 is electrically connected to the fuel cell 70 and is configured to operate with the electricity generated by the fuel cell 70. The refrigeration system 82 is drivable by the actuator 81 to run a refrigeration cycle for cooling an interior of the container 50, which is the main means of cooling the interior of the container 50. Specifically, the actuator 81 and the refrigeration system 82 can be the electric motor and the refrigeration system described in the prior art.

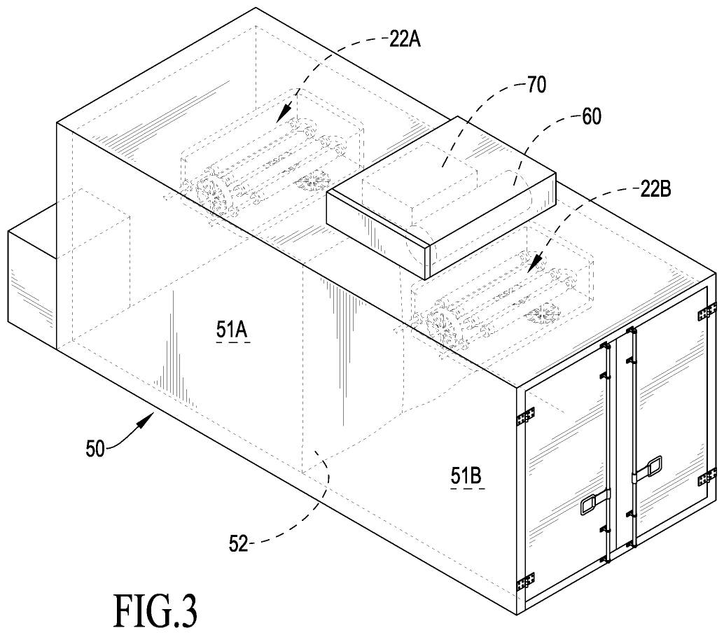

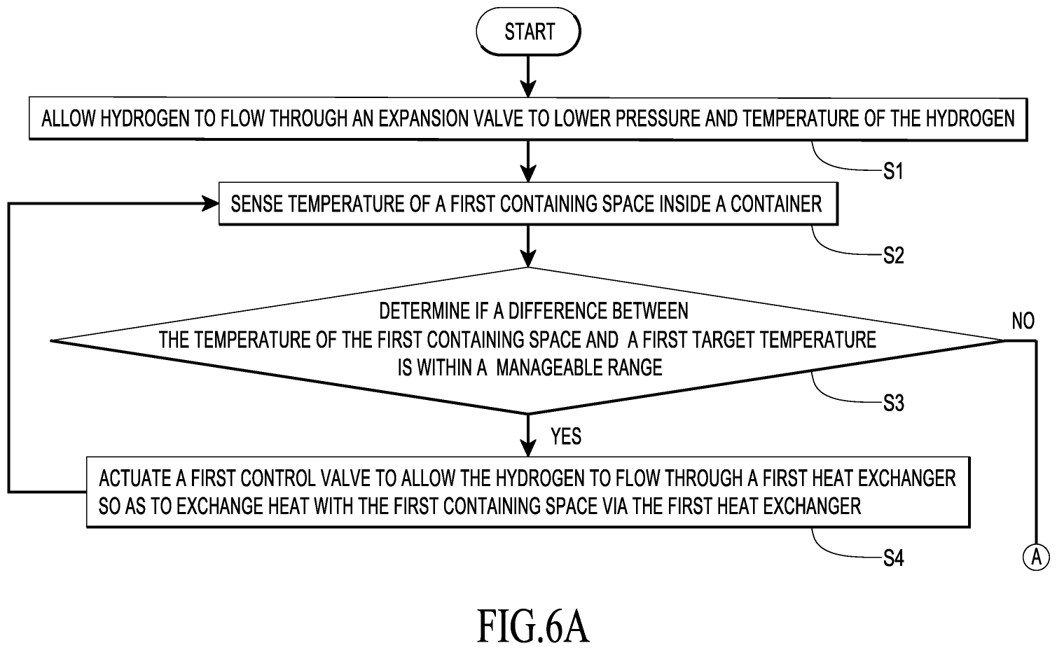

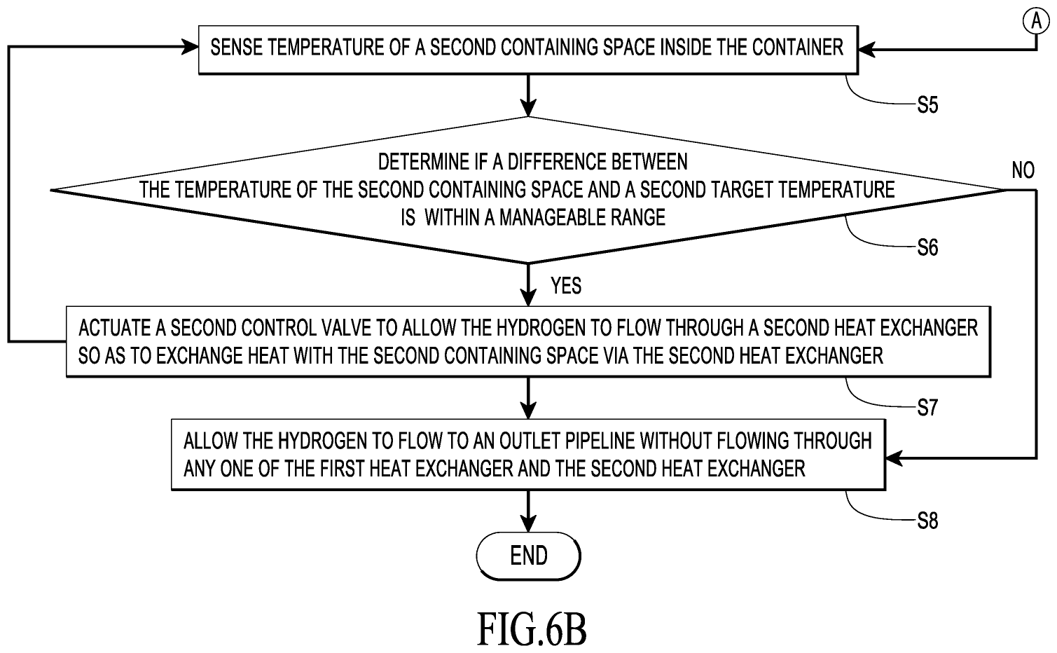

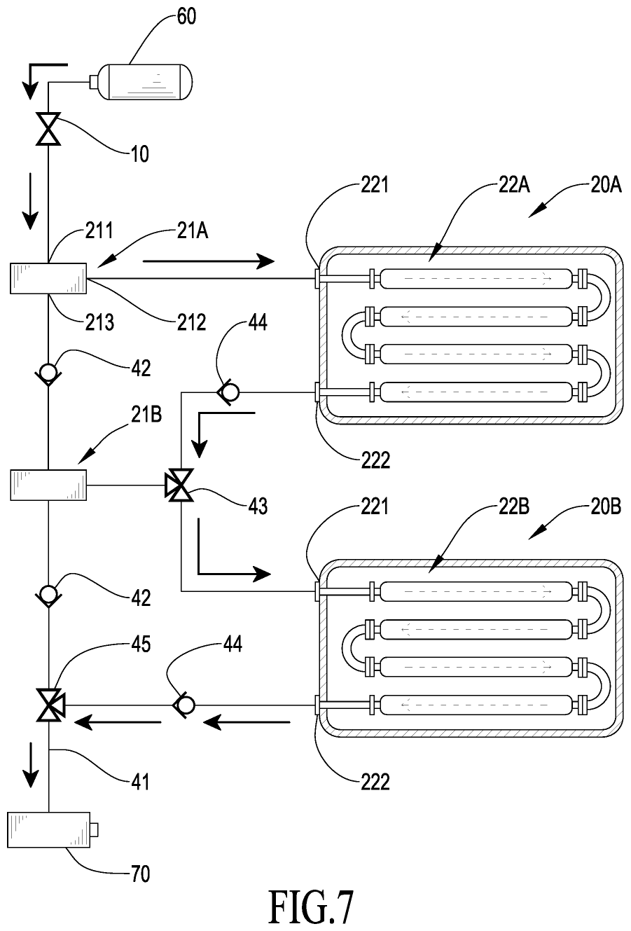

FIGS. 6A and 6B depict the process of a divisional temperature controlling method for the refrigerated containing device applying the hydrogen temperature controlling system of the first preferred embodiment. Processes are described in detail with reference to FIGS. 1 to 9. For better understanding, with reference to FIGS. 3 and 7, the two temperature controlling modules 20 are respectively defined as a first temperature controlling module 20A and a second temperature controlling module 20B; the control valve 21 and the heat exchanger 22 of the first temperature controlling modules 20A are respectively defined as a first control valve 21A and a first heat exchanger 22A; the control valve 21 and the heat exchanger 22 of the second temperature controlling module 20B are respectively defined as a second control valve 21B and a second heat exchanger 22B. The two containing spaces of the container 50 are respectively defined as a first containing space 51A and a second containing space 51B, and the first containing space 51A and the second containing space 51B are separated by an insulation curtain 52, but it is not limited thereto. The first heat exchanger 22A is disposed to the first containing space 51A, and the second heat exchanger 22B is disposed to the second containing space 51B. The thermal sensor 23 of the first temperature controlling modules 20A is configured to measure the temperature of the first containing space 51A, and the thermal sensor 23 of the second temperature controlling modules 20B is configured to measure the temperature of the second containing space 51B.

With reference to FIG. 6A, first, in a hydrogen supplying step S1, allow the hydrogen gas to flow through the expansion valve 10 to lower pressure and temperature of the hydrogen gas. With reference to FIG. 7, specifically, the hydrogen gas with a high pressure is supplied from the storage tank 60 and flows through the expansion valve 10, which lowers the pressure and temperature of the hydrogen gas and makes the hydrogen gas have the capability of heat absorption. After the hydrogen supplying step S1, a first containing space temperature measuring step S2 is run to measure temperature of the first containing space 51A inside the container 50, and specifically the temperature of the first containing space 51A is measured by the thermal sensor 23 of the first temperature controlling module 20A.

With reference to FIG. 6A, a first containing space temperature determining step S3 is run after the first containing space temperature measuring step S2 to determine whether a difference between the temperature of the first containing space 51A and a first target temperature is within a range; specifically, with reference to FIG. 2, the thermal sensor 23 is configured to send a temperature information to the control unit 30 after measuring the temperature of the first containing space 51A, which allows the control unit 30 to receive the temperature information of the first containing space 51A. Then, the control unit 30 compares the temperature of the first containing space 51A with the first target temperature to determine whether the difference between the above two is within the range. In practice, the first containing space 51A can be a freezer compartment of the container 50; the first target temperature can be set at −20 degrees Celsius, and the range can be set higher than 0 degree Celsius and lower than plus 2 degrees Celsius.

With reference to FIGS. 3 and 6A, when the difference between the temperature of the first containing space 51A and the first target temperature is within the range, a first containing space cooling step S4 is then run. In the first containing space cooling step S4, the first control valve 21A is actuated and allows the hydrogen gas to flow through the first heat exchanger 22A so as to exchange heat with the first containing space 51A via the first heat exchanger 22A. With reference to FIGS. 2 and 7, specifically, when the control unit 30 determines that the difference between the temperature of the first containing space 51A and the first target temperature is within the range, the control unit 30 sends an electrical signal to the first control valve 21A and actuates the first control valve 21A. When the hydrogen gas flows to the first control valve 21A from the expansion valve 10, the first control valve 21A leads the hydrogen gas to flow through the first heat exchanger 22A, which enables the heat exchange between the first containing space 51A and the first heat exchanger 22A. Afterwards, the hydrogen gas flows to the outlet pipeline 41 from the first heat exchanger 22A and then to the fuel cell 70 for generating electricity.

After running the first containing space cooling step S4, repeat the first containing space temperature measuring step S2 and the first containing space temperature determining step S3 until the temperature of the first containing space 51A reaches or is lower than the first target temperature. In other words, re-measure the temperature of the first containing space 51A and re-determine whether the difference between the first target temperature and the temperature of the first containing space 51A is within the range until the difference is determined out of the range, and a next step is then run.

With reference to FIGS. 6A and 6B, the difference between the temperature of the first containing space 51A and the first target temperature may be determined out of the range when the temperature of the first containing space 51A reaches or is lower than the first target temperature after repeating the first containing space temperature measuring step S2 and the first containing space temperature determining step S3 or when the temperature of the first containing space 51A is too high while first running the containing space temperature determining step S3. Afterwards, a second containing space temperature measuring step S5 and a second containing space temperature determining step S6 are run to measure the temperature of the second containing space 51B and determine whether a difference between the temperature of the second containing space 51B and a second target temperature is within the range.

Specifically, the second containing space temperature measuring step S5 and the second containing space temperature determining step S6 are similar with the first containing space temperature measuring step S2 and the first containing space temperature determining step S3. The temperature of the second containing space 51B is measured by the thermal sensor 23 of the second temperature controlling modules 20B; with reference to FIG. 2, the thermal sensor 23 is configured to send a temperature information to the control unit 30 after measuring the temperature of the second containing space 51B, which allows the control unit 30 to receive the temperature information of the second containing space 51B. Then, the control unit 30 compares the temperature of the second containing space 51B with the second target temperature to determine whether a difference between the above two is within the range. In practice, the second containing space 51B can be a normal refrigerator compartment of the container 50; the second target temperature can be set at 5 degrees Celsius, and the range is the same as the range in the first containing space temperature determining step S3 and is set higher than 0 degree Celsius and lower than plus 2 degrees Celsius.

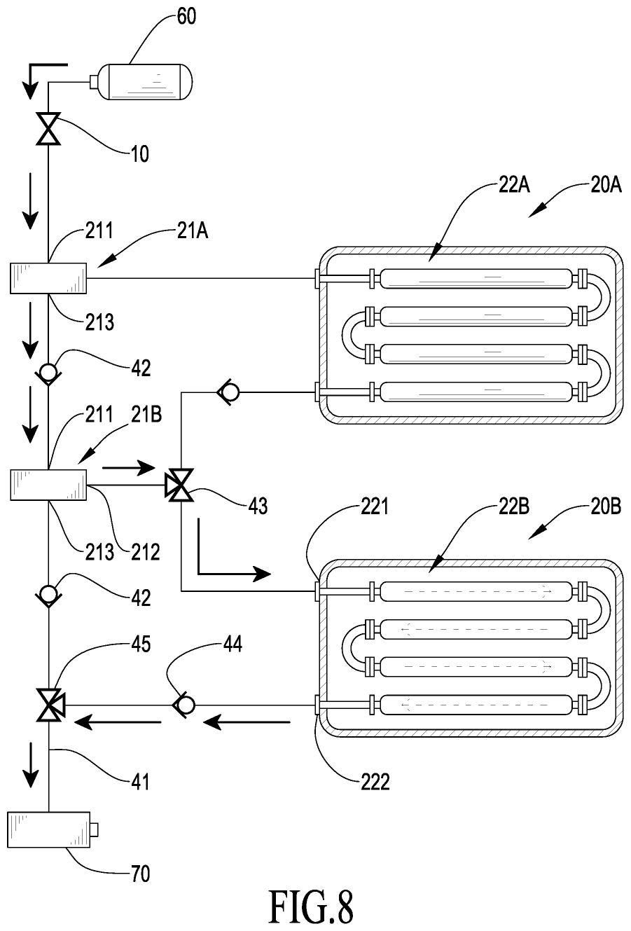

With reference to FIG. 6B, when the difference between the temperature of the second containing space 51B and the second target temperature is within the range, a second containing space cooling step S7 is then run. In the second containing space cooling step S7, the second control valve 21B is actuated and allows the hydrogen gas to flow through the second heat exchanger 22B so as to exchange heat with the second containing space 51B via the second heat exchanger 22B. With reference to FIGS. 2 and 8, specifically, when the control unit 30 determines that the difference between the temperature of the second containing space 51B and the second target temperature is within the range, the control unit 30 sends an electrical signal to the second control valve 21B and actuates the second control valve 21B. When the hydrogen gas flows to the second control valve 21B from the expansion valve 10, the second control valve 21B leads the hydrogen gas to flow through the second heat exchanger 22B, which enables the heat exchange between the second containing space 51B and the second heat exchanger 22B. Afterwards, the hydrogen gas flows to the outlet pipeline 41 from the second heat exchanger 22B and then to the fuel cell 70 for generating electricity.

After running the second containing space cooling step S7, repeat the second containing space temperature measuring step S5 and the second containing space temperature determining step S6 until the temperature of the second containing space 51B reaches or is lower than the second target temperature. In other words, re-measure the temperature of the second containing space 51B and re-determine whether the difference between the second target temperature and the temperature of the second containing space 51B is within the range until the difference is determined out of the range, and a next step is then run.

With reference to FIG. 6B, the difference between the temperature of the second containing space 51B and the second target temperature may be determined out of the range when the temperature of the second containing space 51B reaches or is lower than the second target temperature after repeating the second containing space temperature measuring step S5 and the second containing space temperature determining step S6 or when the temperature of the second containing space 51B is too high while first running the second containing space temperature determining step S6. Afterwards, a hydrogen leading step S8 is then run; in the hydrogen leading step S8, the hydrogen temperature controlling system allows the hydrogen gas to flow to the outlet pipeline 41 without flowing through any one of the first heat exchanger 22A and the second heat exchanger 22A.

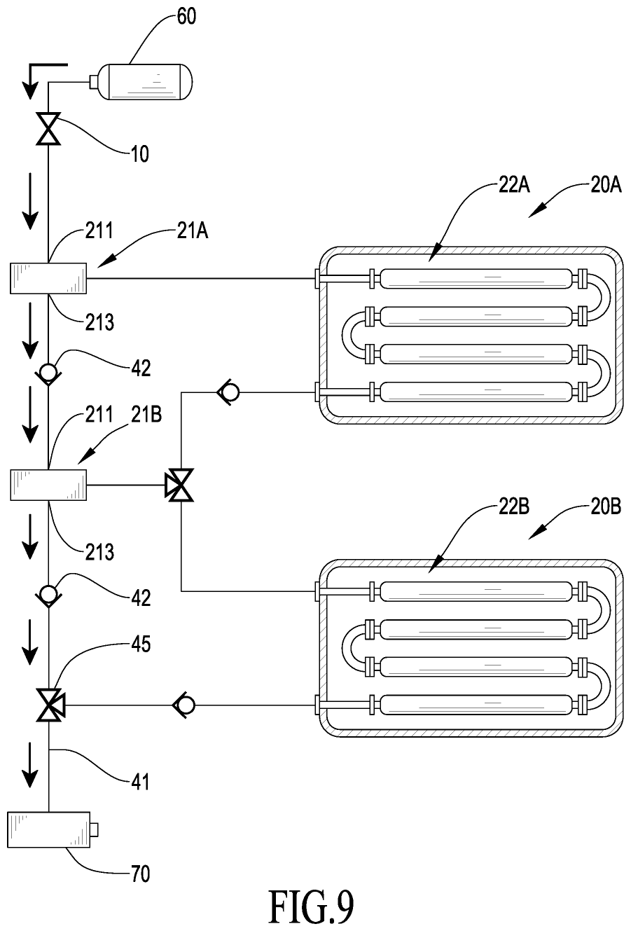

Specifically, when the cooling of the first containing space 51A and the cooling of the second containing space 51B are both finished or when the temperature of the first containing space 51A and the temperature of the second containing space 51B are both too high, the difference between the temperature of the first containing space 51A and the first target temperature and the difference between the temperature of the second containing space 51B and the second target temperature are both out of the range. With reference to FIG. 9, at that time, after the hydrogen gas supplied from the storage tank 60 flows through the expansion valve 10 to lower pressure and temperature of the hydrogen gas, the hydrogen gas flows directly to the outlet pipeline 41 without flowing through any one of the first heat exchanger 22A and the second heat exchanger 22B and then flows to the fuel cell 70 for generating electricity. With reference to FIG. 2, the electricity generated by the fuel cell 70 is the power supply of the control unit 30 and the actuator 81, which enables the actuator 81 to drive the refrigeration system 82. Thus, the refrigeration system 82 runs a refrigeration cycle to cool the first containing space 51A and the second containing space 51B inside the container 50 when the difference between the temperature of the first containing space 51A and the first target temperature and the difference between the temperature of the second containing space 51B and the second target temperature are large.

In practice, in the refrigerated containing device applying the hydrogen temperature controlling system, the refrigeration system 82 driven by the actuator 81 powered by the fuel cell 70 is the main cooling means. When the temperature of the interior of the container 50 rises slightly due to opening of the container 50 for loading or discharge of commodities or due to factors of weather and transport, the hydrogen temperature controlling system can be adopted for cooling. When the hydrogen gas flows through said heat exchanger 22, the capability of heat absorption of the hydrogen gas after decompression enables the heat exchange between said heat exchanger 22 and the corresponding containing space in the container 50, which provides effects of slight cooling and accurate temperature control.

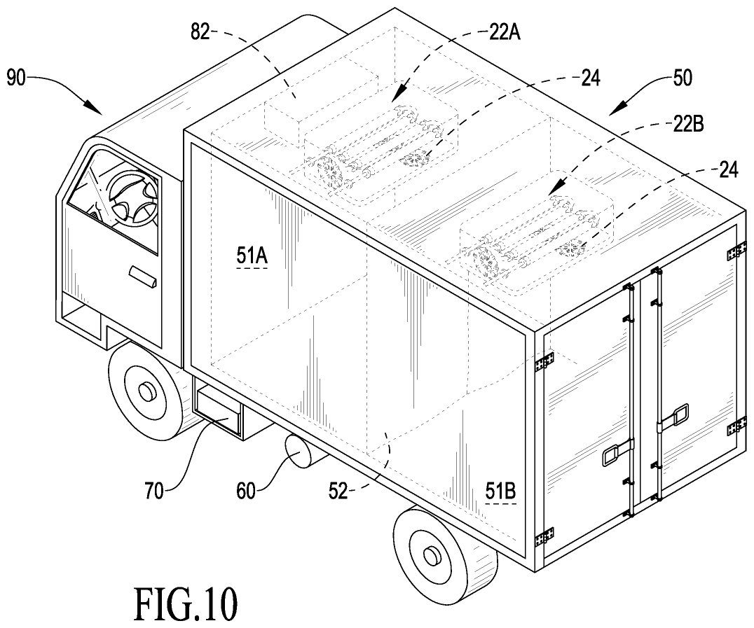

In the industrial application, the refrigerated containing device applying the hydrogen temperature controlling system of the first preferred embodiment can be a warehouse at a fixed spot, or the refrigerated containing device can be disposed on a truck 90 as a truck container of the truck 90, and with reference to FIG. 10, the fuel cell 70 is the power source of the truck 90, which means the truck 90 is a hydrogen vehicle. The present invention is not limited to one specific application.

According to the above description, for the refrigeration container powered by the fuel cell system, the present invention provides the hydrogen temperature controlling system and the refrigerated containing device applying the above system which are applicable to containers with multiple regions having different temperature. While the hydrogen gas being supplied from the storage tank 60 to the fuel cell 70, the hydrogen temperature controlling system divisionally cools the interior of the container 50 via the capability of heat absorption of the hydrogen gas after decompression. For the refrigeration container powered by the fuel cell system, the present invention broadens the application of the fuel cell system and thus improves the cost-effectiveness of the fuel cell system.

The present invention further provides the divisional temperature controlling method for the refrigerated containing device, which monitors the temperature of each containing space inside the container 50 at all times and can adjust flow of the hydrogen gas according to difference between the temperature of each containing space and the corresponding target temperature so as to cool the containing space slightly heated up and accurately control the temperature of each containing space. For the containing space having the temperature much higher than the target temperature, the fuel cell 70 supplies electricity for the refrigeration system 82 to operate and cool said containing spaces, which ensures better cooling efficiency.

In the divisional temperature controlling method for the refrigerated containing device of the present invention, the hydrogen supplying step S1 is first run, and the first containing space temperature measuring step S2 and the first containing space temperature determining step S3 are run next in the first preferred embodiment. In other embodiments, the first containing space temperature measuring step S2 and the first containing space temperature determining step S3 may be run first, and then the hydrogen supplying step S1 is run to allow the hydrogen gas to flow through the expansion valve 10 for the following first containing space cooling step S4. Order of the hydrogen supplying step S1, the first containing space temperature measuring step S2, and the first containing space temperature determining step S3 is not limited by the description in the first preferred embodiment.

Moreover, in the divisional temperature controlling method for the refrigerated containing device of the present invention, the first containing space temperature measuring step S2, the first containing space temperature determining step S3, and the first containing space cooling step S4 are run first, and the second containing space temperature measuring step S5, the second containing space temperature determining step S6, and the second containing space cooling step S7 are run next in the first preferred embodiment. In other embodiments, the steps concerning the first containing space 51A and the steps concerning the second containing space 51B may be run simultaneously. The order of the steps in the divisional temperature controlling method for the refrigerated containing device is according to the configuration of the corresponding hydrogen temperature controlling system and the corresponding refrigerated containing device and is thus not limited by the description of the first preferred embodiment.

In the first preferred embodiment, the hydrogen temperature controlling system has the two temperature controlling modules 20, and the container 50 has the two containing spaces. In other embodiments, the number of the temperature controlling modules 20 in the hydrogen temperature controlling system may be decided according to the number of the containing spaces with different target temperatures in the container 50. The number of the temperature controlling modules 20 and the number of the containing spaces are not limited by the first preferred embodiment.

With reference to FIG. 1, in the first preferred embodiment, the expansion valve 10, said control valves 21 of the multiple temperature controlling modules 20, and the outlet pipeline 41 are sequentially connected in series. Specifically, each control valve 21 has an inlet 211, a first outlet 212, and a second outlet 213. With reference to FIGS. 7 and 8, the inlet 211 of the first control valve 21A is connected to the expansion valve 10, and the inlet 211 of the second control valve 21B is connected to the second outlet 213 of the first control valve 21A. The first outlet 212 is connected to the corresponding heat exchanger 22. The second outlet 213 of the second control valve 21B is connected to the outlet pipeline 41. With reference to FIG. 9, when the hydrogen gas flows through the expansion valve 10, when the first control valve 21A and the second control valve 21B are unactuated, the hydrogen gas sequentially flows through the first control valve 21A and the second control valve 21B to the outlet pipeline 41 without flowing through any one of the first heat exchanger 22A and the second heat exchanger 22B. With reference to FIGS. 7 and 8, when the control unit 30 actuates the first control valve 21A or the second control valve 21B, the hydrogen gas flows through the first control valve 21A or the second control valve 21B, flows to the first heat exchanger 22A or the second heat exchanger 22B from said first outlet 212 of the first control valve 21A or the second control valve 21B, and then flows to the outlet pipeline 41.

In the first preferred embodiment, said control valves 21 of the multiple temperature controlling modules 20 are connected in series. In other embodiments, said control valves 21 of the multiple controlling modules 20 can be in parallel connection, which still enables the hydrogen temperature controlling system to control the temperature divisionally. In the first preferred embodiment, when the containing space corresponding to the heat exchanger 22 of a forward temperature controlling module 20 needs not be cooled, the hydrogen gas is all led to the control valve 21 of a next temperature controlling module 20. When any one of the multiple containing spaces in the container 50 needs to be cooled, the hydrogen gas from the expansion valve 10 all flows through the corresponding control valve 21 and the corresponding heat exchanger 22 so as to exchange heat with the corresponding containing space via the corresponding heat exchanger 22, and then the hydrogen gas flows to the outlet pipeline 41. The capability of heat absorption of the hydrogen gas after decompression can be totally and properly performed. Otherwise, compared to the parallel connection, the serial connection can have a simpler pipeline configuration, which is convenient for design and assembly of the hydrogen temperature controlling system, decreases the total length of the pipeline, and thus decreases leaking risk of the hydrogen gas, and improves the safety in use.

With reference to FIG. 1, in the first preferred embodiment, the hydrogen temperature controlling system further has multiple first check valves 42. Each one of the multiple first check valves 42 is disposed between said control valves 21 of adjacent two of the multiple temperature controlling systems or between the control valve 21 of a respective one of the multiple temperature controlling modules 20 and the outlet pipeline 41. The multiple first check valves 42 prevent the hydrogen gas from flowing backwards and ensure that the hydrogen gas flows through the outlet pipeline 41 and to the fuel cell 70 for generating electricity.

Furthermore, with reference to FIG. 1, in the first preferred embodiment, said heat exchangers 22 of the two temperature controlling modules 20 and the outlet pipeline 41 are sequentially connected in series. Specifically, with reference to FIG. 1, the hydrogen temperature controlling system has a three-way pipe 43, and said heat exchangers 22 of the two temperature controlling modules are connected to each other via the three-way pipe 43. With reference to FIGS. 7 to 9, the three-way pipe 43 is connected to an exit 222 of the first heat exchanger 22A, an entrance 221 of the second heat exchanger 22B, and the first outlet 212 of the second control valve 21B corresponding to the second heat exchanger 22B. The exit 222 of the second heat exchanger 22B is connected to the outlet pipeline 41 via a gathering three-way pipe 45, and the first control valve 21A and the second control valve 21B connected in series are also connected to the outlet pipeline 41 via the gathering three-way pipe 45. When the hydrogen gas flows out from the exit 222 of the first heat exchanger 22A, the hydrogen gas flows through the three-way pipe 43 to the second heat exchanger 22B and then flows through the gathering three-way pipe 45 and the outlet pipeline 41 to the fuel cell 70.

In the first preferred embodiment, the hydrogen temperature controlling further has the heat exchanger 22 of the two temperature controlling modules 20 connected in series. In other embodiments, said heat exchangers 22 of the multiple temperature controlling modules 20 may be in parallel connection and then be connected to the outlet pipeline 41, and the hydrogen gas can still flow through the outlet pipeline 41 to the fuel cell 70 after flowing through the heat exchanger 22. In the first preferred embodiment, the serial connection of said heat exchangers 22 of the multiple temperature controlling modules 20 decreases the total length of the pipeline of the hydrogen temperature controlling system, decreases leaking risk of the hydrogen gas, and thus improves the safety in use.

In addition, the hydrogen temperature controlling system has multiple second check valves 44. Each one of the multiple second check valves 44 is disposed between said heat exchangers 22 of the two temperature controlling modules 20 or the heat exchanger 22 of a respective one of the two temperature controlling modules 20 and the outlet pipeline 41. The multiple second check valves 44 prevent the hydrogen gas from flowing backwards and ensure that the hydrogen gas flows to the outlet pipeline 41 and to the fuel cell 70 from the outlet pipeline 41 for the fuel cell 70 to generate electricity.

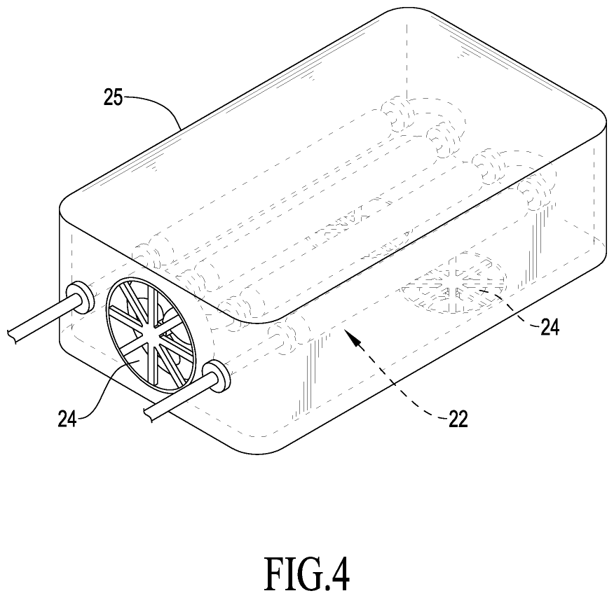

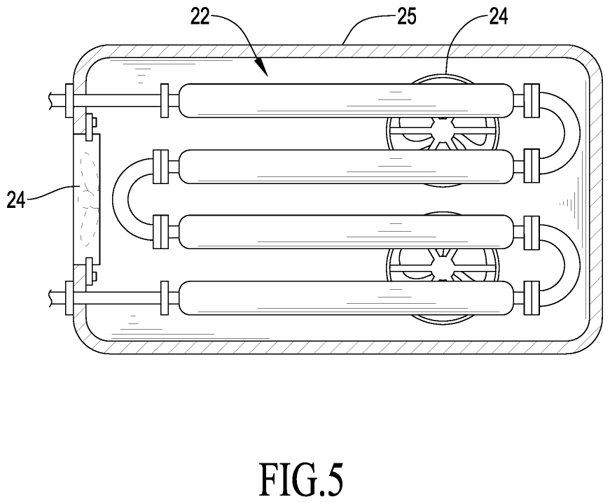

With reference to FIGS. 4 and 5, in the first preferred embodiment, each one of the two temperature controlling modules 20 has three fans 24, and the three fans 24 are disposed near the heat exchanger 22 and are configured to generate convection in the corresponding containing space. Specifically, each one of the two temperature controlling modules 20 has a frame 25 disposed inside the corresponding containing space in the container 50. The heat exchanger 22 is disposed inside the frame 25, and the three fans 24 are mounted on the frame 25 and communicate with an interior of the frame 25 and the corresponding containing space. In use, two of the three fans 24 can be applied for generating airflow from the corresponding containing space into the interior of the frame 25, and the other one of the three fans 24 can be applied for generating airflow from the interior of the frame 25 to the corresponding containing space so as to generate convection in the corresponding containing space. With the configuration of the frame 25 and the three fans 24, the convection can be improved for better heat transfer. In other embodiments, each one of the temperature controlling modules 20 may have only one fan 24 and have an opening defined through the frame 25, and the convection can still be generated. The number of said fan(s) 24 is not limited by the first preferred embodiment.

In the first preferred embodiment, said fans 24 force convection between the periphery of the heat exchanger 22 and the corresponding containing space, which enables all air in the corresponding containing space to flow to the periphery of the heat exchanger 22 to exchange heat with the heat exchanger 22. Thereby, the temperature of every portion in the corresponding containing space can be more consistent, and temperature difference between the portions respectively near the heat exchanger 22 and away from the heat exchanger 22 can be decreased. Also, the heat transfer can be speeded up, and the heat exchange's efficiency of the heat exchanger 22 can be improved.

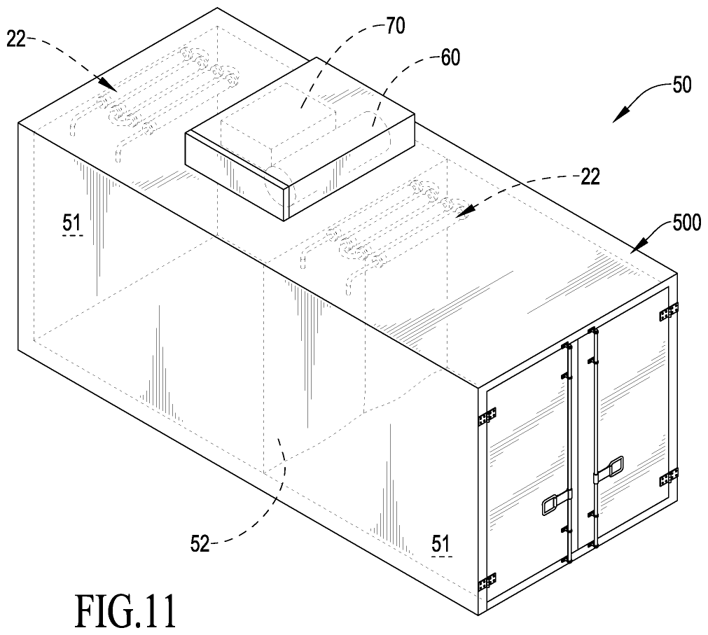

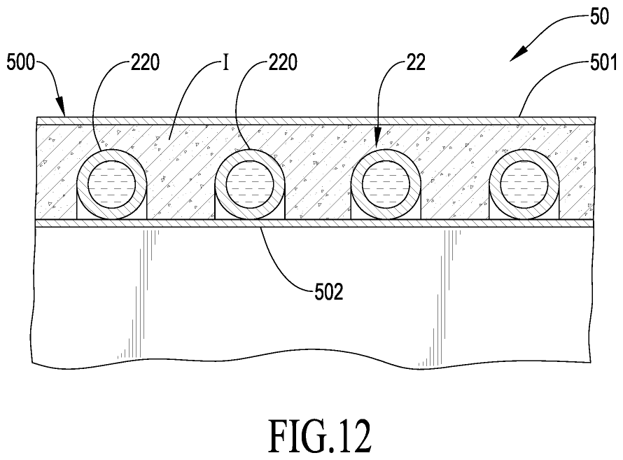

With referenced to FIGS. 11 and 12, the second preferred embodiment in accordance with the present invention provides a refrigerated containing device. Difference between the refrigerated containing device in the second preferred embodiment and the refrigerated containing device described in the first preferred embodiment is assembly of the heat exchanger 22. In the second preferred embodiment, the heat exchanger 22 is disposed inside a body 500 of the container 50. Specifically, with referenced to FIG. 12, the body 500 has an external wall 501 and an internal wall 502, and the heat exchanger 22 is disposed between the internal wall 502 and the external wall 501, and the body 500 also has a thermal insulating material I filled between the internal wall 502 and the external wall 501. The external wall 501 and the internal wall 502 are made of metal such as aluminum or steel to ensure sufficient structural strength, and the thermal insulating material I is applied to decrease heat transfer between the interior of the container 50 and the surrounding of the container 50, which allows the interior of the container 50 to stay at a low temperature and keeps commodities in refrigeration. The heat exchanger 22 has a heat exchanging pipeline 220 attached to the internal wall 502 made of metal material.

In the refrigerated containing device applying the hydrogen temperature controlling system of the first preferred embodiment, said fans 24 and the frame are disposed to generate convection in the corresponding containing space and improve efficiency of heat transfer. In comparison, in the refrigerated containing device of the second preferred embodiment, the heat exchanging pipeline 220 is attached to the internal wall 502, and since the internal wall 502 is made of metal material having great thermal conductivity, the efficiency of heat exchange between the heat exchanger 22 and the corresponding containing space 51 inside the container 50 can be improved, and the corresponding containing space 51 inside the container 50 can be cooled faster.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hydrogen temperature controlling system for supplying hydrogen gas and simultaneously controlling temperatures of multiple containing spaces via the hydrogen gas, the hydrogen temperature controlling system comprising:
an expansion valve configured to allow the hydrogen gas to flow through to lower a pressure and a temperature of the hydrogen gas;
multiple temperature controlling modules, and each one of the multiple temperature controlling modules having
a control valve configured to allow the hydrogen gas from the expansion valve to flow through;
a heat exchanger connected to the control valve and configured to be disposed to a respective one of the multiple containing spaces; and
a thermal sensor configured to be disposed in a respective one of the multiple containing spaces and measure the temperature of the corresponding containing space; and
a control unit electrically connected to the control valve and the thermal sensor of each one of the multiple temperature controlling modules;
wherein the hydrogen temperature controlling system is configured for the hydrogen gas to flow through the expansion valve and said temperature controlling module to an outlet pipeline, and the control unit is configured to operate the control valve of each one of the multiple temperature controlling modules according to the temperature of the corresponding containing space so as to allow the hydrogen gas to flow to the corresponding heat exchanger, so the heat exchanger exchanges heat with the corresponding containing space.

2. The hydrogen temperature controlling system as claimed in claim 1, wherein the expansion valve, said control valves of the multiple temperature controlling modules, and the outlet pipeline are sequentially connected in series to allow the hydrogen gas to sequentially flow through said control valves of the multiple temperature controlling modules and the outlet pipeline without flowing through the heat exchanger of any one of the multiple temperature controlling modules or to allow the hydrogen gas to flow through the control valve and the heat exchanger of one of the multiple temperature controlling modules and the outlet pipeline after the hydrogen gas flows through the expansion valve.

3. The hydrogen temperature controlling system as claimed in claim 2, wherein
the hydrogen temperature controlling system has multiple first check valves; and
each one of the multiple first check valves is disposed between said control valves of adjacent two of the multiple temperature controlling modules or between the control valve of a respective one of the multiple temperature controlling modules and the outlet pipeline.

4. The hydrogen temperature controlling system as claimed in claim 2, wherein
said heat exchangers of the multiple temperature controlling modules and the outlet pipeline are sequentially connected in series;
said heat exchangers of adjacent two of the multiple temperature controlling modules are connected to each other via a three-way pipe; and
the three-way pipe is connected to an exit of one of the two heat exchangers, an entrance of the other one of the two heat exchangers, and the control valve corresponding to the other one of the two heat exchangers.

5. The hydrogen temperature controlling system as claimed in claim 4, wherein
the hydrogen temperature controlling system has multiple second check valves; and
each one of the multiple second check valves is disposed between said heat exchangers of adjacent two of the multiple temperature controlling modules or between the heat exchanger of a respective one of the multiple temperature controlling modules and the outlet pipeline.

6. The hydrogen temperature controlling system as claimed in claim 1, wherein
each one of the multiple temperature controlling modules has at least one fan; and
the at least one fan is disposed near the corresponding heat exchanger and is configured to generate convection in the corresponding containing space.

7. A refrigerated containing device comprising:
the hydrogen temperature controlling system as claimed in claim 1;
a container having the multiple containing spaces disposed therein;
a storage tank configured to store the hydrogen gas and supply the hydrogen gas to the expansion valve of the hydrogen temperature controlling system;
a fuel cell configured to receive the hydrogen gas from the outlet pipeline of the hydrogen temperature controlling system and generate electricity;
an actuator configured to operate with the electricity generated by the fuel cell; and
a refrigeration system being drivable by the actuator to cool an interior of the container.

8. The refrigerated containing device as claimed in claim 7, wherein the expansion valve, said control valves of the multiple temperature controlling modules, and the outlet pipeline are sequentially connected in series to allow the hydrogen gas to sequentially flow through said control valves of the multiple temperature controlling modules and the outlet pipeline without flowing through the heat exchanger of any one of the multiple temperature controlling modules or allow the hydrogen gas to flow through the control valve and the heat exchanger of one of the multiple temperature controlling modules and the outlet pipeline after the hydrogen gas flows through the expansion valve.

9. The refrigerated containing device as claimed in claim 8, wherein
the hydrogen temperature controlling system has multiple first check valves; and
each one of the multiple first check valves is disposed between said control valves of adjacent two of the multiple temperature controlling modules or between the control valve of a respective one of the multiple temperature controlling modules and the outlet pipeline.

10. The refrigerated containing device as claimed in claim 8, wherein
said heat exchangers of the multiple temperature controlling modules and the outlet pipeline are sequentially connected in series;
said heat exchangers of adjacent two of the multiple temperature controlling modules are connected to each other via a three-way pipe; and
the three-way pipe is connected to an exit of one of the two heat exchangers, an entrance of the other one of the two heat exchangers, and the control valve corresponding to the other one of the two heat exchangers.

11. The refrigerated containing device as claimed in claim 10, wherein
the hydrogen temperature controlling system has multiple second check valves; and
each one of the multiple second check valves is disposed between said heat exchangers of adjacent two of the multiple temperature controlling modules or between the heat exchanger of a respective one of the multiple temperature controlling modules and the outlet pipeline.

12. The refrigerated containing device as claimed in claim 7, wherein
each one of the multiple temperature controlling modules has at least one fan; and
the at least one fan is disposed near the heat exchanger and is configured to generate convection in the corresponding containing space.

13. The refrigerated containing device as claimed in claim 7, wherein
the container has an internal wall and an external wall arranged at a spaced interval;
the heat exchanger of each one of the temperature controlling modules is disposed between the internal wall and the external wall and has a heat exchanging pipeline attached to the internal wall; and
the container has a thermal insulating material filled between the internal wall and the external wall.

14. A divisional temperature controlling method for a refrigerated containing device comprising the following steps:
allowing hydrogen gas to flow through an expansion valve to lower a pressure and a temperature of the hydrogen gas;
measuring a temperature of a first containing space inside a container;
determining whether a difference between the temperature of the first containing space and a first target temperature is within a range;
when the difference between the temperature of the first containing space and the first target temperature is within the range, actuating a first control valve to allow the hydrogen gas to flow through a first heat exchanger so as to exchange heat with the first containing space via the first heat exchanger;
measuring a temperature of a second containing space inside the container;
determining whether a difference between the temperature of the second containing space and a second target temperature is within the range; and
when the difference between the temperature of the second containing space and the second target temperature is within the range, actuating a second control valve to allow the hydrogen gas to flow through a second heat exchanger so as to exchange heat with the second containing space via the second heat exchanger.

15. The divisional temperature controlling method for the refrigerated containing device as claimed in claim 14, wherein, after exchanging heat with the first containing space via the first heat exchanger, re-measure the temperature of the first containing space and re-determine whether the difference between the temperature of the first containing space and the first target temperature is within the range.

16. The divisional temperature controlling method for the refrigerated containing device as claimed in claim 14, wherein, after exchanging heat with the second containing space via the second heat exchanger, re-measure the temperature of the second containing space and re-determine whether the difference between the temperature of the second containing space and the second target temperature is within the range.

17. The divisional temperature controlling method for the refrigerated containing device as claimed in claim 14, wherein, when the difference between the temperature of the first containing space and the first target temperature is out of the range, measure the temperature of the second containing space.

18. The divisional temperature controlling method for the refrigerated containing device as claimed in claim 17, wherein, when the difference between the temperature of the second containing space and the second target temperature is out of the range, allow the hydrogen gas to flow to an outlet pipeline without flowing through any one of the first heat exchanger and the second heat exchanger.
